(19) United States
(12) Patent Application Publication
(10) Pub. No.: US 2026/0189293 A1
(43) Pub. Date: Jul. 2, 2026

(54) METHOD AND APPARATUS FOR WIRELESS COMMUNICATION

(71) Applicant: QUECTEL WIRELESS SOLUTIONS CO., LTD., Shanghai (CN)

(72) Inventors: Ling LYU, Frisco, TX (US); Zheng ZHAO, Shanghai (CN)

(21) Appl. No.: 19/549,848

(22) Filed: Feb. 25, 2026

Related U.S. Application Data
(63) Continuation of application No. PCT/CN2024/128564, filed on Oct. 30, 2024.

(51) Int. Cl. H04B 7/06; H04L 41/16; H04W 16/28; H04W 72/231; H04W 76/20

(52) U.S. Cl. CPC H04B 7/06968; H04L 41/16; H04W 16/28; H04W 72/231; H04W 76/20

(57) ABSTRACT

A method and apparatus for wireless communication are provided. One example method includes: receiving first indication information, wherein the first indication information indicates a first quasi co-location (QCL) relationship; and determining, based on the first QCL relationship, at least one of the following: a beam set used for at least one of model training or model inference, wherein an element of the first QCL relationship comprises an identifier of the beam set; or a plurality of optimal beams in a model prediction result.

### CROSS-REFERENCE TO RELATED APPLICATIONS

This application is a continuation of International Application No. PCT/CN2024/128564, filed on Oct. 30, 2024, the disclosure of which is hereby incorporated by reference in its entirety.

### TECHNICAL FIELD

The present application relates to the field of communication technologies, and more specifically, to a method and apparatus for wireless communication.

### BACKGROUND

In some beam management scenarios, a terminal device may predict a downlink transmit beam by using a model and report the predicted downlink transmit beam to a network device. The model is required to be trained before it can be used for inference and prediction. However, there may be a time interval between a training phase and an inference phase. If a transmission condition of a beam changes, the model may have an error during the inference phase. Therefore, how to ensure consistency of the model between the training phase and the inference phase is an urgent technical problem to be resolved.

### SUMMARY

The present application provides a method and apparatus for wireless communication. Various aspects of embodiments of the present application are described below.

According to a first aspect, a method for wireless communication is provided. The method includes: receiving, by a first device, first indication information, where the first indication information is used to indicate a first quasi co-location (quasi co-located, QCL) relationship; and performing, by the first device, a first operation based on the first QCL relationship, where the first operation is one or more of following: determining a beam set used for model training and/or model inference, where an element of the first QCL relationship includes an identifier of the beam set; or determining a plurality of optimal beams in a model prediction result.

According to a second aspect, a method for wireless communication is provided. The method includes: transmitting, by a second device, first indication information to a first device, where the first indication information is used to indicate a first QCL relationship, and the first QCL relationship is used by the first device to perform a first operation, where the first operation is one or more of following: determining a beam set used for model training and/or model inference, where an element of the first QCL relationship includes an identifier of the beam set; or determining a plurality of optimal beams in a model prediction result.

According to a third aspect, an apparatus for wireless communication is provided. The apparatus is a first device, and includes: a transceiver unit, receiving first indication information, where the first indication information is used to indicate a first QCL relationship; and a processing unit, performing a first operation based on the first QCL relationship, where the first operation is one or more of following: determining a beam set used for model training and/or model inference, where an element of the first QCL relationship includes an identifier of the beam set; or determining a plurality of optimal beams in a model prediction result.

According to a fourth aspect, an apparatus for wireless communication is provided. The apparatus is a second device, and includes: a transceiver unit, transmitting first indication information to a first device, where the first indication information is used to indicate a first QCL relationship, and the first QCL relationship is used by the first device to perform a first operation, where the first operation is one or more of following: determining a beam set used for model training and/or model inference, where an element of the first QCL relationship includes an identifier of the beam set; or determining a plurality of optimal beams in a model prediction result.

According to a fifth aspect, a communications apparatus is provided, and includes a memory and a processor, where the memory is configured to store a program, and the processor is configured to invoke the program in the memory to execute the method according to the first aspect or the second aspect.

According to a sixth aspect, an apparatus is provided, and includes a processor, invoking a program from a memory to execute the method according to the first aspect or the second aspect.

According to a seventh aspect, a chip is provided, and includes a processor, invoking a program from a memory, to cause a device on which the chip is installed to execute a method according to the first aspect or the second aspect.

According to an eighth aspect, a computer-readable storage medium is provided, where the computer-readable storage medium stores a program, and the program causes a computer to execute the method according to the first aspect or the second aspect.

According to a ninth aspect, a computer program product is provided, and includes a program, where the program causes a computer to execute the method according to the first aspect or the second aspect.

According to a tenth aspect, a computer program is provided, where the computer program causes a computer to execute the method according to the first aspect or the second aspect.

In embodiments of the present application, a first device (for example, a terminal device) may determine a first QCL relationship based on first indication information. In a case that an element of the first QCL relationship includes an identifier of a beam set, the first QCL relationship may be used to determine a beam set used for model training and/or model inference, so as to improve accuracy of beam prediction by ensuring consistency of the beam set. The first QCL relationship may be further used to determine a plurality of optimal beams in a model prediction result, which is conducive to reducing a quantity of beams that are required to be measured individually.

### BRIEF DESCRIPTION OF THE DRAWINGS

FIG. 1 shows a wireless communications system to which embodiments of the present application are applied.

FIG. 2 is a schematic diagram of a model processing process to which embodiments of the present application are applied.

FIG. 3 is a schematic diagram of a beam relationship in a model training and model inference process.

FIG. 4 is a schematic flowchart of a method for wireless communication according to an embodiment of the present application.

FIG. 5 is a schematic diagram of another possible implementation of the method shown in FIG. 4.

FIG. 6 is a schematic diagram of a structure of an apparatus for wireless communication according to an embodiment of the present application.

FIG. 7 is a schematic diagram of a structure of another apparatus for wireless communication according to an embodiment of the present application.

FIG. 8 is a schematic diagram of a structure of an apparatus for wireless communication according to an embodiment of the present application.

### DETAILED DESCRIPTION OF THE EMBODIMENTS

The following describes the technical solutions in embodiments of the present application with reference to the accompanying drawings.

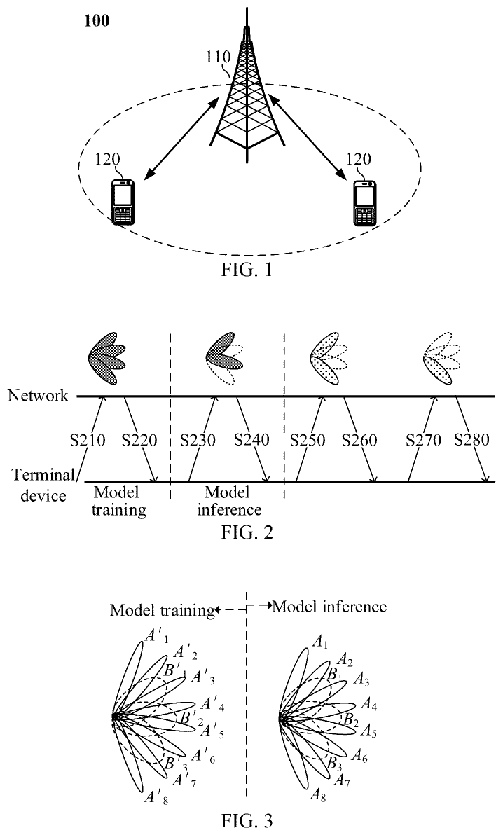

FIG. 1 is a schematic diagram of an architecture of a wireless communications system 100 to which embodiments of the present application are applied. As shown in FIG. 1, the wireless communications system 100 may include a network device 110 and a terminal device 120. The network device 110 may be a device that communicates with the terminal device 120. The network device 110 may provide communication coverage for a specific geographic area, and may communicate with a terminal device within the coverage.

FIG. 1 exemplarily shows one network device and two terminal devices. Optionally, the wireless communications system 100 may include a plurality of network devices, and another quantity of terminal devices may be included in coverage of each network device, which is not limited. That is, the wireless communications system may include one or more network devices, and each network device may support wireless communication of one or more terminal devices.

In embodiments of the present application, the communications system shown in FIG. 1 may further include other network entities such as a mobility management entity (mobility management entity, MME), an access and mobility management function (access and mobility management function, AMF), and a network controller, which is not limited in embodiments of the present application.

It should be understood that embodiments of the present application may be applied to various communications systems. For example, embodiments of the present application may be applied to a global system for mobile communications (global system of mobile communication, GSM), a code division multiple access (code division multiple access, CDMA) system, a wideband code division multiple access (wideband code division multiple access, WCDMA) system, a general packet radio service (general packet radio service, GPRS) system, a long term evolution (long term evolution, LTE) system, an advanced long term evolution (advanced long term evolution, LTE-A) system, a new radio (new radio, NR) system, an evolved system of an NR system, an LTE-based access to unlicensed spectrum (LTE-based access to unlicensed spectrum, LTE-U) system, an NR-based access to unlicensed spectrum (NR-based access to unlicensed spectrum, NR-U) system, a universal mobile telecommunications system (universal mobile telecommunication system, UMTS), a wireless local area network (wireless local area networks, WLAN) system, a wireless fidelity (wireless fidelity, WiFi) system, and a 5th-generation (5th-generation, 5G) communications system. Embodiments of the present application may be further applied to another communications system, for example, a future communications system such as a 6th-generation (6th-generation, 6G) mobile communications system or a satellite (satellite) communications system.

Conventional communications systems support a limited quantity of connections and are easy to implement. However, with development of communications technologies, a communications system may support not only conventional cellular communications but also one or more other types of communications. For example, the communications system may support one or more types of the following communication: device-to-device (device to device, D2D) communication, machine-to-machine (machine to machine, M2M) communication, machine type communication (machine type communication, MTC), enhanced machine type communication (enhanced MTC, eMTC), vehicle-to-vehicle (vehicle to vehicle, V2V) communication, vehicle-to-everything (vehicle to everything, V2X) communication, and the like. Embodiments of the present application may also be applied to a communications system that supports the foregoing communication manners.

The communications system in embodiments of the present application may be applied to a carrier aggregation (carrier aggregation, CA) scenario, a dual connectivity (dual connectivity, DC) scenario, or a standalone (standalone, SA) networking scenario.

The communications system in embodiments of the present application may be applied to unlicensed spectrum. The unlicensed spectrum may also be considered as shared spectrum. Alternatively, the communications system in embodiments of the present application may be applied to licensed spectrum. The licensed spectrum may also be considered as dedicated spectrum.

Embodiments of the present application may be applied to a non-terrestrial network (non-terrestrial network, NTN) system. In an example, the NTN system may be a 4G-based NTN system, an NR-based NTN system, an NTN system based on an internet of things (internet of things, IoT), or an NTN system based on a narrow band internet of things (narrow band internet of things, NB-IoT).

The wireless communications system in embodiments of the present application may use the following resources to support wireless communication with one or more communications devices: time resources (for example, symbols, subslots, slots, subframes, and frames) or frequency resources (for example, subcarriers and carriers). Additionally, the wireless communications system may support wireless communication across various radio access technologies (radio access technology, RAT). The various radio access technologies include 3rd generation (3G) radio access technologies, 4th generation (4G) radio access technologies, 5th generation (5G) radio access technologies, and other suitable radio access technologies beyond 5G.

The terminal device in embodiments of the present application may also be referred to as user equipment (user equipment, UE), an access terminal, a subscriber unit, a subscriber station, a mobile site, a mobile station (mobile station, MS), a mobile terminal (mobile terminal, MT), a remote station, a remote terminal, a mobile device, a user terminal, a terminal, a user communications device, a wireless communications device, a user agent, or a user apparatus.

In some embodiments, the terminal device in embodiments of the present application may be a device providing a user with voice and/or data connectivity and capable of connecting people, objects, and machines, such as a handheld device or a vehicle-mounted device having a wireless connection function. The terminal device in embodiments of the present application may be a mobile phone (mobile phone), a tablet computer (Pad), a notebook computer, a palmtop computer, a mobile internet device (mobile internet device, MID), a wearable device, a virtual reality (virtual reality, VR) device, an augmented reality (augmented reality, AR) device, a wireless terminal in industrial control (industrial control), a wireless terminal in self-driving (self driving), a wireless terminal in remote medical surgery (remote medical surgery), a wireless terminal in smart grid (smart grid), a wireless terminal in transportation safety (transportation safety), a wireless terminal in smart city (smart city), a wireless terminal in smart home (smart home), or the like. Optionally, the UE may be configured to function as a base station. For example, the UE may function as a scheduling entity, which provides a sidelink signal between UEs in V2X, D2D, or the like. For example, a cellular phone and a vehicle communicate with each other by using a sidelink signal. A cellular phone and a smart home device communicate with each other, without relaying a communication signal through a base station.

In some embodiments, the terminal device may be a station (STATION, ST) in a WLAN. In some embodiments, the terminal device may be a cellular phone, a cordless phone, a session initiation protocol (session initiation protocol, SIP) phone, a wireless local loop (wireless local loop, WLL) station, a personal digital assistant (personal digital assistant, PDA) device, a handheld device with a wireless communication function, a computing device, or another processing device connected to a wireless modem, a vehicle-mounted device, a wearable device, a terminal device in a next-generation communications system (such as an NR system), a terminal device in a future evolved public land mobile network (public land mobile network, PLMN), or the like.

The network device in embodiments of the present application may be a device for communicating with the terminal device. The network device may also be referred to as an access network device or a wireless access network device. The network device may be, for example, a base station. The network device in embodiments of the present application may be a radio access network (radio access network, RAN) node (or device) that connects the terminal device to a wireless network. The base station may broadly cover various names in the following, or may be interchanged with the following names, for example, a NodeB (NodeB), an evolved NodeB (evolved NodeB, eNB), a next generation NodeB (next generation NodeB, gNB), a relay station, an access point, a transmitting and receiving point (transmitting and receiving point, TRP), a transmitting point (transmitting point, TP), a master eNodeB (MeNB), a secondary eNodeB (SeNB), a multi-standard radio (MSR) node, a home base station, a network controller, an access node, a wireless node, an access point (access point, AP), a transmission node, a transceiver node, a base band unit (base band unit, BBU), a remote radio unit (remote radio unit, RRU), an active antenna unit (active antenna unit, AAU), a remote radio head (remote radio head, RRH), a central unit (central unit, CU), a distributed unit (distributed unit, DU), a positioning node, a network communications device, or the like. The base station may be a macro base station, a micro base station, a relay node, a donor node, or the like, or a combination thereof. Alternatively, the base station may be a communications module, a modem, or a chip disposed in the device or the apparatus described above. Alternatively, the base station may be a mobile switching center, a device that functions as a base station in D2D, V2X, or M2M communications, a network-side device in a 6G network, a device that functions as a base station in a future communications system, or the like. The base station may support networks of a same access technology or different access technologies. A specific technology and a specific device used by the network device are not limited in embodiments of the present application.

The base station may be stationary or mobile. For example, a helicopter or an unmanned aerial vehicle may be configured to function as a mobile base station, and one or more cells may move depending on a location of the mobile base station. In other examples, a helicopter or an unmanned aerial vehicle may be configured to function as a device in communication with another base station.

In some deployments, the network device in embodiments of the present application may be a CU or a DU, or the network device includes a CU and a DU. The gNB may further include an AAU.

The network device and the terminal device may be deployed on land, including being indoors or outdoors, handheld, or vehicle-mounted, may be deployed on a water surface, or may be deployed on a plane, a balloon, or a satellite in the air. In embodiments of the present application, a scenario of the network device and the terminal device is not limited.

It should be understood that all or a part of functions of the communications device in the present application may also be implemented by software functions running on hardware, or by virtualization functions instantiated on a platform (for example, a cloud platform).

In embodiments of the present application, the network device may provide a service for a cell. The terminal device communicates with the network device by using a transmission resource (for example, a frequency resource or a spectrum resource) used by the cell. The cell may be a cell corresponding to the network device (for example, a base station). The cell may belong to a macro station or may belong to a base station corresponding to a small cell (small cell). The small cell herein may include a metro cell (metro cell), a micro cell (micro cell), a pico cell (pico cell), a femto cell (femto cell), or the like. These small cells have characteristics of small coverage and low transmit power, and are suitable for providing a high-rate data transmission service.

It should be understood that a device having a communication function in a network/system in embodiments of the present application may be referred to as a communications device. The wireless communications system 100 shown in FIG. 1 is used as an example. The communications device may include a network device 110 and a terminal device 120 that have a communication function, and may further include another device in the wireless communications system 100, for example, another network entity such as a network controller or a mobility management entity, which is not limited in embodiments of the present application.

For ease of understanding, some relevant technical knowledge related to embodiments of the present application is first described. The following related technologies, as optional solutions, may be randomly combined with the technical solutions of embodiments of the present application, all of which fall within the protection scope of embodiments of the present application. Embodiments of the present application include at least a part of the following content.

In a wireless communications system, a terminal device may obtain a beam (which may also be referred to as a spatial beam), to implement a wireless connection from the terminal device to a wireless network. For example, the terminal device may perform beam sweeping on an available beam transmitted by the wireless network, and measure attributes of the beam. The attributes of the beam are, for example, signal strength and signal quality. For example, after performing beam sweeping, the terminal device may further perform beam refinement, to achieve a group of potentially narrower beams used for wireless connection to the wireless network. The beam may not only implement wireless connection between the terminal device and the wireless network, but also implement high directional precision and high signal quality for wireless signal transmission between the terminal device and the wireless network.

With development of communication technologies, research on artificial intelligence (artificial intelligence, AI)/machine learning (machine learning, ML) technologies based on air interfaces of communication systems (for example, NR systems) becomes one of directions. An objective of the research includes exploring how to enhance an advantage of the air interface. For example, related performance of the air interface can be enhanced by enhancing support for AI/ML algorithms. For another example, complexity and/or overheads of the air interface can be reduced by enhancing support for AI/ML algorithms.

Research on AI/ML technologies can also enhance functions related to beam management (beam management, BM). In an example, AI/ML enhancements related to beam management may support reduced overheads and reduced beam measurement and reporting delays. In an example, an AI/ML model may be applied to predict a beam, so as to improve transmission efficiency of the air interface.

A whole process of applying an AI/ML model for enhancement includes: model training, model inference, and model monitoring. In this process, the AI/ML model, after being trained, can generate a set of outputs based on a set of inputs. The input may be a set of beam measured values, and the output may be a set of beams different from or larger than the input.

In a model inference process, the AI/ML model can predict a best beam in a set of different or larger set of beams by using a set of beam measured values.

In some embodiments, the AI/ML model may be located on a terminal device side or the terminal device performs model training and/or model inference. The model may be referred to as a UE-side model (UE-side model). For example, the AI model is located at the terminal device, and training of the AI model and/or generation of a best beam by inference using the AI model may be performed at the terminal device or by the terminal device.

In an example, the terminal device may use a beam in a set B (Set B, also referred to as beam group B) as an input of the ML model. The ML model may predict a best beam in a set A (Set Aⱼ, also referred to as beam group A), and the beam is not completely measured by the terminal device.

In the example described above, the set B may be a beam group first measured by the terminal device. The set B may be a plurality of beams transmitted by a base station (for example, a gNB). Each beam may correspond to a different direction or angle, so as to cover a plurality of spatial directions. Each beam may further correspond to a measurement signal, which is used to obtain a measured value, such as a reference signal received power (reference signal received power, RSRP). The set B is used to provide the model with preliminary ambient information and channel conditions.

In the example described above, the set A may be a beam group that needs to be predicted. The set A usually has a larger quantity of beams than set B, or may have more concentrated beam directions. The AI/ML model may predict a best beam in the set A by measuring the set B, to improve data transmission efficiency.

Optionally, beams in the set A and the set B may be in a same frequency range. Selection of the set B may be given by the base station or determined by the terminal device itself. A relationship between the set A and the set B may be that: the set A is different from the set B (the set B is not a subset of the set A), the set B is a subset of the set A (the set A is different from the set B), or the set A and the set B are the same. For the first two cases, the set B may be transmitted in both a measurement window and a prediction window, or may be transmitted only in a measurement window. For the last case, reference signal (reference signal, RS) transmission overheads may be reduced, and the set B used as measurement resources may be transmitted only in the measurement window.

Optionally, 64 or more beams may be used as a size of the beam set A. For future-oriented networks, a network device will be able to transmit 64 more highly directional narrow beams. More narrow beams may also be used to sweep a larger set A. For example, the quantity of beams in the set A may be as large as 256.

Optionally, the network device may transmit a channel state information reference signal (channel state information-reference signal, CSI-RS) or a synchronization signal block (synchronization signal block, SSB) as a reference signal. It should be understood that the SSB may also represent a synchronization signal/physical broadcast channel block (synchronization signal/physical broadcast channel block, SS/PBCH block). The SSB includes a primary synchronization signal (primary synchronization signal, PSS) and a secondary synchronization signal (secondary synchronization signal, SSS).

Optionally, the terminal device estimates channel quality of each beam by measuring an RSRP of the received CSI-RS/SSS.

Optionally, in a model training process, the AI/ML model may adjust its weights by minimizing a loss function, so that the model can accurately predict a best beam in the set A from an RSRP measurement result of the set B.

In some embodiments, the AI/ML may be located on a network device (such as a base station) side, or the network device performs model training and/or model inference. The model may be referred to as a network-side model (NW-side model). For example, the AI model is located at the base station, and training of the AI model and/or generation of a best beam by inference using the AI model may be performed at the base station or by the base station.

In some embodiments, a network may completely control a data collection process of model training on the terminal device side, including starting, termination, and management of data collection and data transmission.

During a model monitoring process, AI/ML model monitoring is used for at least the following purposes: model activation, deactivation, selection, switching, rollback, and updating (including retraining). The model monitoring may also be referred to as a process of monitoring AI/ML model inference performance. There is definitely a time interval between model training and inference. When radio parameters/conditions change in the network, there is a high probability of errors occurring in an inference phase of a model, and therefore the model needs to be continuously modified and trained based on a result of the model monitoring. In addition, in some cases, model monitoring may be required before the model is used in a new radio environment/condition/parameter.

In an example, due to different mobile environments, each model has a model identity (identity, ID) to facilitate model identification.

In comparison with other beam management technologies, based on beam prediction, the terminal device can experience a reduced delay, reduced overheads, reduced power consumption, and improved signal quality by using beam management that supports the AI/ML technology.

For ease of understanding, the following describes an entire process of model processing on the terminal device side with reference to FIG. 2. FIG. 2 is shown from a perspective of interaction between a terminal device side (for example, UE) and a network (network, NW) side. Four beams on the network side are used as an example. It can be learned from FIG. 2 that the entire process may include a model training (model training) process, a model inference (model inference) process, and a reporting process. The model training process includes Step S210 and Step S220, and the model inference process includes Step S230 and Step S240.

Refer to FIG. 2. In Step S210, the terminal device reports training-related information (UE report training-related information).

In Step S220, the network side performs beam sweeping (beam scanning) based on the four beams.

In Step S230, the terminal device reports inference-related information (UE report inference-related information).

In Step S240, the network side selects two beams from the four beams based on the reporting from the terminal device to perform beam sweeping.

In Step S250, the terminal device reports K optimal beams (top-K beam report).

In Step S260, the network side performs beam sweeping based on beams in the beam report. It can be learned from FIG. 2 that the two beams on which the network side performs beam sweeping in Step S260 may be different from the two beams on which the network side performs beam sweeping in Step S240.

In Step S270, the terminal device transmits a beam report (beam report), so that the network side determines an optimal beam.

In Step S280, the network side transmits a beam indication (beam indication) to the terminal device.

The foregoing describes, with reference to FIG. 2, a process of processing a model when the model is located on the terminal device side. To complete the entire process, the terminal device is further required to collect and analyze data, to perform model training. The model inference process is mainly used for beam prediction.

In related scenarios, the terminal device may support beam prediction in spatial domain and/or time domain, that is, BM-Case1 and/or BM-Case2. Based on AI/ML enhancements, the beam prediction in spatial domain (BM-Case1) and the beam prediction in time domain (BM-Case2) can reduce overheads of the terminal device and decrease delays in beam measurement and reporting.

BM-Case1 is spatial domain downlink (downlink, DL) beam prediction for the set A based on a measurement result of the set B. For BM-case 1, measured values of the set B (measurements based on Set B of beams) are used as model input to predict the top-1/top-K beams in the set A.

BM-Case2 is time domain DL beam prediction for the set A based on a historical measurement result of the set B. For BM-Case2, measured values of the beams in the set B at one or more historical time instances (measurements based on Set B of beams at historic time instance(s)) may be used as a model input, to predict time domain DL beams of the beams in the set A. Prediction of DL Tx beams and prediction of DL Tx/Rx beams may also be used to evaluate prediction performance.

For BM-Case1 and BM-Case2, the terminal device may report a prediction result to the NW based on outputs of the terminal device-side model, or the NW may predict top-1/top-K beams based on a measurement report of the set B of the NW-side model.

The terminal device-side model is still used as an example. For a training and inference process of a terminal device-side AI/ML model, a conventional transmission configuration indicator (transmission configuration indicator, TCI) state mechanism may be used for beam indication of a beam. Optionally, the terminal device may report a measurement result of four or more beams in one reporting instance.

In an example, in a beam management inference process, the beam indication is important information. After the terminal device reports the top-K predicted beams, the NW further indicates beams used for second-step measurement, or the terminal device may directly trigger the second-step measurement. For BM-Case2, the model is required to obtain top-K beams corresponding to each of a plurality of time instances. Therefore, time information is required to be considered for beam indication on a network device side. For example, for BM-Case2 with the AI/ML model located on the terminal device side, the terminal device may report the following information related to AI/ML model inference to the NW in a report example: beams to be used in N future times instances output based on the AI/ML model inference; timestamp information corresponding to the reported beams; and information about measured values from a plurality of past time instances.

In an example, a TCI state may be used to indicate beam information used for transmitting a physical downlink shared channel (physical downlink shared channel, PDSCH) or a physical downlink control channel (physical downlink control channel, PDCCH).

In an example, in a 5G NR system, a TCI state defines beam selection and transmission configuration for a downlink. A main function of the TCI state is to help the terminal device learn a beam or antenna configuration used by a base station (for example, a gNB) during transmission of some physical channels (such as a PDSCH or a PDCCH). Each TCI state corresponds to a specific beam configuration. Generally, each TCI state is associated with a specific beam or a plurality of beams (via a QCL relationship). For example, for a unified TCI framework, if there is no PDSCH transmission when a best beam between the base station and the terminal device changes, the network indicates a corresponding TCI state to the terminal device by using downlink control information (downlink control information, DCI). If there is a PDSCH for transmission, the base station transmits DCI with downlink (downlink, DL) allocation to the terminal device, and a TCI field is always present in the DCI.

Optionally, the network device may transmit the control information by using a PDCCH, that is, transmit the DCI by using the PDCCH.

The QCL relationship may also be referred to as a quasi co-location relationship. To ensure consistency of a demodulation reference signal (demodulation reference signal, DMRS) of a PDSCH/PDCCH in the NR among different timestamps, it may be implemented by a QCL relationship mechanism, especially during the training and inference process of the model.

The following describes a QCL configuration used to indicate the QCL relationship in a beam indication.

The QCL relationship is generally used to mark similarity between channel characteristics of some transmit resources (such as a CSI-RS resource). Through the QCL configuration, the terminal device may infer channel states of a plurality of resources by using a same set of measurement results, without measuring and evaluating each beam individually. The QCL relationship defines similarity between channel characteristics of two (or more) beams or resources in terms of space, frequency, time, and the like. In other words, in a case that two or more beams have a QCL relationship, channel characteristics of the two or more beams are similar.

In some embodiments, QCL is generally defined in the following several dimensions: delay spread, angular spread, and Doppler spread. The delay spread refers to a case in which a difference in time of arrival between signals from two beams is very small, so that they may share same time domain processing. The angular spread refers to a case in which angles of arrival of signal sources are nearly the same, so that beams may share spatial processing. The Doppler spread refers to a case in which signal sources have similar velocities and thus similar Doppler shifts, so that they may share frequency domain processing. During beam management, if two resources have a same QCL level in these characteristics, the terminal device may infer that channel states of these resources are similar, and therefore it is not required to measure a channel state of each beam individually.

In some embodiments, for a set across antenna ports, a QCL type may be used to indicate which channel characteristics are common. For example, a plurality of QCL types (QCL types) supported by a protocol may be used to indicate a QCL relationship between a DMRS in a PDSCH and a tracking reference signal (tracking reference signal, TRS).

In an example, for a given QCL association, a maximum of one or two QCL types may be used to indicate the QCL relationship. In a case that two QCL types are used for indication, a same RS may be used to indicate the QCL. Table 1 shows definitions of four different QCL types.

TABLE 1

| QCL type | Description (description) |
|---|---|
| QCL type A | Doppler shift, Doppler spread, |
| | average delay, and delay spread |
| QCL type B | Doppler shift, and Doppler spread |
| QCL type C | Average delay, and Doppler shift |
| QCL type D | Spatial receiver parameter |

As shown in Table 1, the QCL type may be defined as a QCL type A (QCL-TypeA), a QCL type B (QCL-TypeB), a QCL type C (QCL-TypeC), and a QCL type D (QCL-TypeD). Referring to Table 1, the QCL type A indicates common Doppler shift (Doppler shift), Doppler spread (doppler spread), average delay (average delay), and delay spread (delay spread). The QCL type B indicates common Doppler shift and Doppler spread. The QCL type C indicates common average delay and Doppler shift. The QCL type D indicates common spatial receiver parameter (spatial Rx parameter).

Optionally, the spatial receiver parameter may include a beamforming property of a downlink received signal, such as a dominant angle of arrival of a signal, an average angle of arrival at the terminal device, or another beamforming property.

Optionally, the QCL information may help the terminal device perform beam tracking, time-frequency offset tracking, and demodulation. For example, beam tracking may be performed using the QCL type D. For another example, time/frequency offset tracking may be performed using the QCL type A/B/C.

It may be learned from the foregoing description that a training and inference process of the AI/ML model involves two beam sets: a set A and a set B. A beam in the set A may have a certain QCL relationship with a beam in the set B. For example, a beam in the set A during training has a QCL relationship with a beam in the set A during inference. For another example, a beam in a set B during training has a QCL relationship with a beam in a set B used during inference.

In an example, during model training and inference based on QCL, a QCL type may be configured for a resource of each beam in the set A and a transmit beam related to the resource. In the training and inference process, beams used by the network device for the set A have similar channel characteristics in spatial domain, time domain, and frequency domain. Since beam characteristics remain consistent, a channel state of a CSI-RS resource measured by the terminal device during the training phase may be used during the inference phase. For resources in the set B, the terminal device may also consider that transmit beams used during training and inference have a same QCL relationship. A beam measurement result obtained in the training phase may be directly applied to the inference phase.

In an example, in a case that transmit (transmission, Tx) beams of the network device have a QCL relationship shown in Table 1, consistency of channel characteristics may be ensured. For ease of understanding, the following provides an example description with reference to a QCL relationship between beams in the set B and beams in the set A shown in FIG. 3.

Referring to FIG. 3, in the model training process, a beam in the set A is Aⱼ′, where 1≤j≤8; and a beam in the set B is Bₖ′, where 1≤k≤3. In the model inference process, a beam in the set A is Aⱼ, and a beam in the set B is Bₖ. As shown in FIG. 3, the beam Aⱼ′ during model training and the beam Aⱼ during model inference have similar channel characteristics; and the beam Bₖ′ during model training and the beam Bₖ during model inference have similar channel characteristics. That is, the beam Aⱼ′ during training has a QCL relationship with the beam Aⱼ during inference, and the beam Bₖ′ during training has a QCL relationship with the beam Bₖ during inference.

The foregoing describes, with reference to FIG. 2 and FIG. 3, a procedure of performing beam management based on the AI/ML model and a QCL relationship between beams. AI/ML-based beam management enhancements still face some problems to be solved or studied.

In an example, when a terminal device uses an AI algorithm or an ML algorithm to process beams detected and measured from a wireless network to infer other beams that may have higher strength and/or higher quality, the terminal device is required to ensure consistency of the model between the training phase and the inference phase. As previously described, there is a time interval between the training phase and the inference phase, and changes in radio parameters/conditions may cause errors in the inference phase. For example, for a beam prediction use case, the terminal device may use a limited beam measurement set (for example, a beam group B) as input to the ML model. When the ML model predicts a best beam or an optimal beam from a set of beams (for example, a beam group A) that are not fully measured by the terminal device, there is a relatively high probability of errors occurring during the inference phase of the model. This is because during the time interval between the model training process and the model inference process, the network may experience changes in radio parameters/conditions, which results in a relatively high error rate.

In an example, when a QCL relationship is introduced, a plurality of QCL types corresponding to a conventional QCL relationship may fail to ensure beam consistency between model training and model inference. This is because, in some scenarios, an element of the conventional QCL type may change relatively quickly. When a QCL element changes, the QCL relationship changes, which triggers a new beam set, consistency of a beam sequence/index between the model training process and the model inference process may not be ensured, and even consistency of a beam shape cannot be ensured. Therefore, the model is required to be updated. For example, in a scenario in which the terminal device moves at a high speed, changes in geographic characteristics lead to rapid changes in Doppler shift. Once the Doppler shift changes, a model trained based on a previous beam set is required to be updated. However, frequent updates of the model are not conducive to beam prediction based on the model. It may be learned that the consistency of the beam sequence/index and the consistency of the beam shape cannot be ensured by relying on an existing QCL type (for example, the QCL type D).

In an example, if the terminal device is moving at a high speed, a best beam between the network device and the terminal device may frequently change, and the network is required to frequently transmit DCI to indicate a new TCI state, resulting in relatively large overheads.

In an example, in a related 3rd Generation Partnership Project (3rd generation partnership project, 3GPP) standard, a maximum trigger state quantity regarding the TCI state in non-periodic CSI reporting is 128. The quantity includes beam reports and other triggers. However, a quantity of optimal beam combinations output by the model far exceeds the quantity. For example, if there are 32 beams in the set A and the model outputs top-4 predicted beams from the set A, a quantity of all possible combinations output by the AI/ML model is C₃₂⁴=35960. It is impossible for the network to configure all possible combinations of four beams in the set A, which also brings complexity to the network in triggering a second round of beam sweeping for top-4 beams.

In view of this, an embodiment of the present application provides a method for wireless communication. In this method, the terminal device may determine, based on a first quasi co-location (QCL) relationship in first indication information, a beam set used for model training and/or model inference, or may determine a plurality of optimal beams in a prediction result based on the first QCL relationship. In a case that the first QCL relationship is used to determine the beam set, an element corresponding to the first QCL relationship includes an ID of the beam set, so as to more accurately maintain beam consistency, thereby improving prediction accuracy.

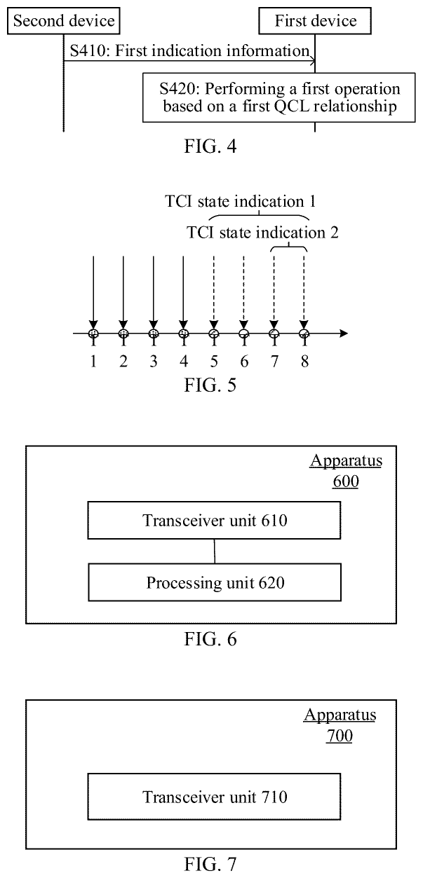

The method for wireless communication proposed in embodiments of the present application is described in detail below with reference to FIG. 4. FIG. 4 is described from a perspective of interaction between a first device and a second device.

The first device may be any type of terminal device described above, or may include any type of terminal device. For example, the first device is UE. For another example, the first device may include a terminal device and any processing device used for beam prediction.

In some embodiments, the first device supports function enhancements based on AI/ML operations. For example, the first device has a function of enhancing beam management based on an AI/ML operation.

In some embodiments, a first model is deployed on the first device, to implement beam prediction. When the second device is a network device, the first device performs DL beam prediction. When the second device is a terminal device, the first device performs sidelink beam prediction.

In an example, the first model is a model that supports an AI algorithm or ML algorithm, that is, the first model is an AI/ML model.

In an example, beam prediction implemented by the first model may be the foregoing BM-Case1, may be BM-Case2, or may be another future beam prediction type, which is not limited herein.

In some embodiments, the first model is deployed on a first device side. The first model may not be located on the terminal device, but on a server communicating with the terminal device. For example, the first model is located on an over-the-top (over the top, OTT) server directly communicating with the terminal device.

The second device may be any network device communicating with the first device, or may be a terminal device communicating with the first device. When the first device is within coverage of the network device, the second device may be the network device. In a sidelink communications system, when the first device communicates with another terminal device, the second device may be the another terminal device.

In some embodiments, the second device may monitor a process in which the first device processes the first model. For example, the second device may determine, based on a report transmitted by the first device, whether the first model is currently in the training phase or the inference phase.

In some embodiments, the second device supports AI/ML operations. The first model may be deployed on a second device side.

In some embodiments, the second device may transmit a plurality of beams to the first device a plurality of times, so that the first device performs measurement, and performs model training and model inference for the first model based on a measurement result.

In the embodiment described above, regardless of whether the first model is deployed on the terminal device side or the network device side, the first model may be one of a plurality of models deployed on the side. The plurality of models may be used to predict transmit beams from different scenarios or different beam transmission devices.

Referring to FIG. 4, in Step S410, the first device receives first indication information. In an example, the first device may receive the first indication information transmitted by the network device (the second device). In an example, the first device may receive the first indication information indicated by using higher-layer signalling.

The first indication information is used to indicate a first QCL relationship. In an example, the first indication information may indicate that a QCL relationship of a beam or a beam resource is the first QCL relationship. For example, the first indication information is used to indicate that a first beam or a first beam resource has the first QCL relationship. For another example, the first indication information is used to indicate that a plurality of beams or a plurality of beam resources have the first QCL relationship.

In some embodiments, the first indication information is used to indicate that all beams in a beam set have the first QCL relationship. The beam set may be a beam set related to a training and inference process of the first model. For example, a beam set having the first QCL relationship may be the set A or the set B described above, where the set B may be referred to as a first beam set, and the set A may be referred to as a second beam set.

In some embodiments, the first indication information is one piece of indication information indicating a beam transmission configuration, that is, the first indication information may include TCI information. For example, the first indication information may be TCI information to indicate a TCI state of one or more beams. For example, the first indication information is first TCI information. For another example, the first indication information may include TCI information to indicate a TCI state and other information. A TCI state of one or more beams in the first indication information is described in detail below with reference to FIG. 5, and details are not described.

In some embodiments, the first indication information may be carried in control signalling. In an example, the first indication information may be carried in one of the following information: DCI, or radio resource control (radio resource control, RRC) signalling. For example, the network device may transmit indication information of one or more beams by using a DCI format. For another example, the network device may transmit a beam indication by using RRC signalling, and this beam indication may be associated with a plurality of TCI states.

An element of the first QCL relationship may refer to one or more elements used to describe the first QCL relationship. The one or more elements may represent a beam characteristic or a channel characteristic or a spatial characteristic of a beam resource. That is, the first indication information may indicate, based on one or more elements, which characteristics of beams are similar or correlated under the first QCL relationship.

In some embodiments, the element of the first QCL relationship includes an identifier of a beam set, that is, a beam set ID. The beam set is used for model training and/or model inference of the first model. It may be learned from the foregoing description that consistency of a beam sequence/index in a beam set cannot be ensured based on a conventional QCL type. To achieve consistency between training and inference, a new element is required to be added to the QCL relationship or a new QCL type is required to be configured. In a case that the element of the first QCL relationship includes an ID of a beam set, using this QCL framework in an AI/ML beam management mechanism may ensure consistency between training and inference, as well as consistency of beams corresponding to different timestamps.

In an example, the beam set may be the first beam set described above, or a second beam set, or a first beam set and a second beam set. The beam set may alternatively be one or more beam sets in different processing phases of the model.

In an example, an ID of a beam set may also be referred to as a beam ID (beam ID) or a transmission ID (transmission ID).

In an example, an identifier of a beam set may be an associated ID between beam sets. Consistency of beam indexing/sorting may be implemented based on a same associated ID and a same set A (or set B) resource. That is, an assumption of the first device for transmit beams having a same associated ID and a same resource index may replace an assumption of the first device for consistency of a beam shape and consistency of beam indexing/sorting. For example, for each resource of the set A, it may be assumed, based on a same associated ID during training and inference, that transmit beams used during training and inference have a certain QCL relationship (the first QCL relationship). For another example, for each resource of the set B, it may also be assumed, based on a same associated ID, that transmit beams used during training and inference have the first QCL relationship.

In an example, the element of the first QCL relationship includes a beam set ID, which may implement a beam ID tracking mechanism. The beam ID tracking mechanism may ensure that the first device learns which beam or transmission is being received, even in a case in which a signal is slightly adjusted due to channel changes. The beam ID tracking mechanism may further maintain a beam identity across slots to provide continuity of signal processing and demodulation. It may be learned that the first device may always maintain a consistent understanding of a same beam at different timestamps based on the first QCL relationship, that is, consistency of channel properties of a same beam among different timestamps may be ensured, especially in scenarios of Doppler effects and delay evolution.

In the example described above, the beam ID tracking mechanism may involve an explicit beam or a CSI-RS resource identifier carried or embedded in a DMRS signal by using higher-layer signalling. In this indication manner, it is ensured that even in a case of beam switching or reconfiguration, the first device may maintain an understanding of a consistent transmission source. In addition, since a transmission identity of a beam may be ensured over time, the first device can accurately track a specific beam regardless of a change in a channel condition or minor beam adjustments. Even if there is a slight change in transmission (for example, a Doppler shift, a channel change, or the like), the beam may maintain a consistent transmission identity, which is critical to long-term data transmission and high mobility scenarios.

In some embodiments, the element of the first QCL relationship further includes one or more of the following: a time instance (time instance) related to model training and/or model inference; or a spatial filter parameter related to a beam set.

In an example, the time instance related to model training and/or model inference may be used to determine a time resource of a beam, thereby determining beam information in a model training or model inference process.

In an example, the spatial filter parameter may refer to a spatial receiver parameter and/or a spatial transmitter parameter. The spatial filter parameter related to a beam set includes an ID spatial parameter (ID spatial parameter) related to a beam set ID.

In an example, in a case that the element of the first QCL relationship includes the spatial filter parameter, the model training and the model inference correspond to a same spatial filter. That is, a spatial transmit filter solution based on a beam set ID may ensure beam consistency. For example, for each resource of the set A, a same associated ID during model training and model inference may correspond to a case in which the network device uses a same spatial Tx filter in the model training and model inference process. For another example, for each resource of the set B, the first device may consider that the network device uses a same spatial Tx filter in the model training and model inference process. From a practical perspective, using a same spatial Tx filter during inference and training helps ensure beam consistency.

It should be noted that the element indicating the first QCL relationship may include not only the beam set ID, the time instance, and the spatial filter parameter mentioned above, but also an element in a plurality of existing QCL types, or may include another element associated with the beam set ID. In some scenarios, the element of the first QCL relationship may alternatively include only an element in a conventional QCL type. This is described below with reference to a first operation in Step S420.

In some embodiments, the first QCL relationship may be indicated by one or more QCL types. The one or more QCL types may be conventional QCL types in Table 1, or may be QCL types newly designed for beam consistency. Four conventional QCL types are the QCL type A, the QCL type B, the QCL type C, and the QCL type D in Table 1, respectively. In addition, to ensure beam consistency among different timestamps, a new QCL type, namely, a QCL type E, may be designed to indicate the first QCL relationship. The QCL type E may be a type that implements time and spatial consistency, to ensure robust beam tracking and state sensing across slots.

In an example, the first QCL relationship may be indicated by using a QCL type, namely, a first QCL type.

In an example, the first QCL relationship may be indicated by using a plurality of QCL types. For example, the first QCL relationship may be indicated by using two QCL types. The two QCL types may include a first QCL type and a second QCL type.

In an example, the QCL type E may integrate an element of an existing QCL type, and an additional mechanism may be added to support consistency of channel properties and beam identifiers at a timestamp level.

In an example, the QCL type E may be described by using a new element. The new element may include the beam set ID described above, and may further include a time instance related to model training and/or model inference, and a spatial filter parameter related to a beam set.

In the example described above, the newly added QCL type E may ensure time and spatial consistency by using the ID. In a case that the QCL type E includes a beam set ID, a time instance, and a spatial filter parameter, a time (time instance-based) and space (beam-based) consistency mechanism is integrated to ensure ID consistency of a given transmission among a plurality of timestamps. In a high mobility environment (such as vehicles or high-speed trains) with frequent Doppler effects and beam switching, maintaining consistent beam identifiers across timestamps is critical for stable data transmission. For example, for beam tracking of a multi-slot PDSCH, in a case that data of the PDSCH spans a plurality of slots, the QCL type E may ensure that the first device can consistently demodulate signals by using a same beam identifier, thereby improving reliability. For another example, in a case that beam consistency among a plurality of frames is relatively important, the QCL type E may ensure that the first device maintains a connection with the same beam, even if rapid reconfiguration is required due to signal blockage or beam sweeping.

In the example described above, the QCL type E may include some or all of the elements indicating the first QCL relationship. For example, Table 2 shows a plurality of QCL types obtained after the QCL type E is newly added, where the QCL type E includes all of the elements indicating the first QCL relationship.

TABLE 2

| QCL type | Description |
|---|---|
| QCL type A | Doppler shift, Doppler spread, |
| | average delay, and delay spread |
| QCL type B | Doppler shift, and Doppler spread |
| QCL type C | Average delay, and Doppler shift |
| QCL type D | Spatial receiver parameter |
| QCL type E | Beam set ID, time instance, |
| | and spatial filter parameter |

In Table 2, the new QCL type E may ensure that the first device can maintain a same transmission identity (ID) at different timestamps when handling changes in channel properties, Doppler effects, and space. Over time, even if a channel condition changes, consistency of a beam identifier or a beam set identifier between the model training phase and the model processing phase can be achieved by tracking the beam set ID.

In an example, the new QCL type may not be added, but instead elements such as the beam set ID, the time instance, and the spatial filter parameter that are included in the first QCL relationship may be integrated into an existing QCL type. In a case that some or all of these elements are integrated into the QCL type A, the QCL type B, the QCL type C, or the QCL type D, the first QCL relationship may not only encompass conventional parameters such as Doppler shift, delay spread, and spatial characteristic, but also support a new beam ID tracking mechanism.

In the example described above, a plurality of elements indicating the first QCL relationship may be added to the QCL type A, the QCL type B, the QCL type C, and/or the QCL type D in various combinations, thereby forming a plurality of new QCL types. The following uses Table 3 and Table 4 as examples for description. It should be understood that manners of adding shown in Table 3 and Table 4 are merely two examples, which does not constitute a limitation.

In Table 3, a plurality of elements indicating the first QCL relationship are added to the QCL type D to form a new QCL type D.

TABLE 3

| QCL type | Description |
|---|---|
| QCL type A | Doppler shift, Doppler spread, |
| | average delay, and delay spread |
| QCL type B | Doppler shift, and Doppler spread |
| QCL type C | Average delay, and Doppler shift |
| New QCL | Spatial receiver parameter, |
| type D | beam set ID, time instance, and |
| | spatial filter parameter |

In Table 4, a plurality of elements indicating the first QCL relationship are respectively added to the QCL type B, the QCL type C, and the QCL type D, thereby forming a new QCL type B, a new QCL type C, and a QCL type D.

TABLE 4

| QCL type | Description |
|---|---|
| QCL | Doppler shift, Doppler spread, |
| type A | average delay, and delay spread |
| New QCL | Doppler shift, Doppler spread, |
| type B | and spatial filter parameter |
| New QCL | Average delay, Doppler shift, |
| type C | and time instance |
| New QCL | Spatial receiver parameter, |
| type D | and beam set ID |

In some embodiments, the first QCL relationship may be indicated by using a first QCL type. In a case that a plurality of elements indicating the first QCL relationship are respectively added to conventional QCL types, the first QCL type may be one, including one of the plurality of elements, of a new QCL type A, a new QCL type B, a new QCL type C, or a new QCL type D. In a case that some or all of the elements indicating the first QCL relationship form a QCL type E, the first QCL type may be the QCL type E. Therefore, in a case that the first QCL relationship is indicated by using a first QCL type, the first QCL type is one of the following: a QCL type A, a QCL type B, a QCL type C, a QCL type D, or a QCL type E. The QCL type A, the QCL type B, the QCL type C, and the QCL type D are new QCL types to which new elements are added.

In some embodiments, the first QCL relationship may be indicated by using a plurality of QCL types, such as a first QCL type and a second QCL type. In some scenarios, for a given QCL association, a maximum of two QCL types may be used to indicate the QCL relationship. For the two QCL types, a same RS may be used to indicate the QCL relationship.

In an example, the first QCL type may include some or all of the elements indicating the first QCL relationship, and the second QCL type may be a conventional QCL type. For example, in a case that the first QCL type is the QCL type E, the second QCL type includes at least one of a conventional QCL type A, QCL type B, QCL type C, or QCL type D.

In the example described above, the QCL type E is configured to be used jointly with any one, or any two, or three/all of the QCL type B, the QCL type C, and the QCL type D, to better indicate the first QCL relationship and ensure beam consistency.

In an example, for a DMRS of a PDSCH, the first device may expect that a TCI state indicates the following QCL type. For example, in a non-zero power (non-zero power, NZP) CSI-RS resource set, configuration may be performed by using a higher-layer parameter trs-Info. The parameter trs-Info may configure a QCL type A corresponding a CSI-RS resource and, when applicable, a QCL type E with the same CSI-RS resource.

In an example, in a case that a plurality of elements indicating the first QCL relationship are added to the QCL type D, the higher-layer parameter trs-Info may configure a QCL type A corresponding to a CSI-RS resource in an NZP CSI-RS resource set and, when applicable, a QCL type D with the same CSI-RS resource.

Still referring to FIG. 4, in Step S420, the first device performs a first operation based on the first QCL relationship. That is, when performing the first operation, the first device is required to consider whether a beam or a beam set has the first QCL relationship. The first operation may be determining a beam set used for model training and/or model inference, or may be determining a plurality of optimal beams (also referred to as best beams) in a model prediction result, or may be determining a beam set used for model training and/or model inference and a plurality of optimal beams in a model prediction result.

In some embodiments, in a case that the element of the first QCL relationship includes a beam set ID or another new element, the first operation may be determining a beam set used for model training and/or model inference. That is, the first device may determine, based on the first QCL relationship that includes the beam set ID, a beam set used for training and inference of the first model. The first QCL relationship that includes the beam set ID is introduced, so that the first device may ensure beam consistency between the model training process and the model inference process, thereby improving prediction accuracy.

In an example, the first QCL relationship may be used to determine a first beam set (the set B) and/or a second beam set (the set A). That is, the first device may determine the set B and/or the set A by using the first QCL relationship.

In an example, in a model training and model inference process of the first model, a correlation may be represented by the first QCL relationship. For resources of the set A and the set B, having the first QCL relationship may ensure a beam correlation between the model training phase and the model inference phase.

In an example, the beam set used for model training and/or model inference further meets one or more of the following conditions: a first beam set used for the model training and a first beam set used for the model inference have the first QCL relationship; a second beam set used for the model training and a second beam set used for the model inference have the first QCL relationship; a first beam set and a second beam set that are used for the model training have the first QCL relationship; or a first beam set and a second beam set that are used for the model inference have the first QCL relationship. As described above, the first beam set is used to determine a plurality of optimal beams from the second beam set.

In some embodiments, the first operation may be determining a plurality of optimal beams (for example, K optimal beams, where K is a positive integer) in a model prediction result based on the first QCL relationship. The first QCL relationship may be a dynamic QCL relationship, so as to ensure that a plurality of optimal beams have same or similar channel characteristics/spatial characteristics. For example, the dynamic QCL relationship may refer to that a system dynamically adjusts a QCL relationship between different beams through channel measurement or AI/ML prediction. The dynamic property of the QCL relationship is that the QCL relationship varies with changes in channel conditions. The network device is required to dynamically calculate and adjust the QCL state based on a channel measurement result or update of the AI/ML model.

In an example, the plurality of optimal beams have the first QCL relationship, and the first QCL relationship is used to determine one or more of the following: the plurality of optimal beams correspond to a same channel characteristic; the plurality of optimal beams correspond to a same delay characteristic; the plurality of optimal beams correspond to a same beam set identifier; or the plurality of optimal beams correspond to a same spatial parameter or spatial filter parameter. It may be learned that the plurality of optimal beams predicted by using the AI/ML model may share some or all of channel characteristics. That is, when the plurality of optimal beams are determined based on the first QCL relationship, the first device may share channel information between beams, thereby reducing overheads caused by measuring beams individually. For example, for each combination of top-K beams, the QCL relationship may be dynamically defined, so that the first device shares a CSI measurement result between the plurality of beams.

In an example, the first QCL relationship may be used by the first model to output K optimal beams in the second beam set.

In an example, after the first model outputs prediction information of all beams in the second beam set, the first QCL relationship may be used by the first device to determine K optimal beams in the second beam set. Through estimation and calculation of the dynamic QCL relationship, the network device may generate a new trigger state for each predicted combination of top-K beams, and configure the trigger state to the first device together with a corresponding QCL relationship.

It should be understood that in a case that the first operation is determining a plurality of optimal beams, the element of the first QCL relationship is not limited. For example, the element of the first QCL relationship may include at least one of the beam set ID, the time instance, or the spatial filter parameter described above. For another example, the element of the first QCL relationship may not include a new element, and the first device determines an optimal beam based on only a conventional QCL element.

In an example, the AI/ML model may predict top-K beams based on historical data and real-time measurement, thereby reducing unnecessary beam sweeping. The dynamic QCL relationship allows the system to flexibly adjust a correlation between beams based on channel changes and a mobility mode of the first device, so as to improve adaptability of the system. For example, the AI/ML model on the first device side may predict most likely top-K beams in the second beam set by using a historical CSI-RS, and RSRP measured value and/or ambient information (for example, geographic location information, or a moving speed).

In an example, the predicted top-K beams may be represented as: B_{pred}={B₁, B₂, B₃, . . . . B_{K}}. Based on the predicted top-K beams, the network device may dynamically determine a QCL relationship between these beams through measurement or channel model analysis. It is assumed that a QCL relationship between beams may be determined based on their channel characteristics (for example, an angle, a delay, or a Doppler shift). For example, if the plurality of beams have similar angular distribution and a delay difference on a propagation path is relatively small or less than a threshold, these beams may have a QCL relationship.

In the example described above, the first QCL relationship may be represented as follows at an instant t:

$$QCL ( {B}_{i} , {B}_{j} , t ) = \begin{matrix}1 & if {B}_{i} has the first QCL relationship with {B}_{j} ; \\ 0 & otherwise ;\end{matrix}$$

In which, Bᵢ, Bⱼ belong to B_{pred}, and Bᵢ and B; having the first QCL relationship indicates that the two beams share same channel characteristics.

In an example, the plurality of optimal beams include a first beam and a second beam, and a difference between two channel characteristics respectively corresponding to the first beam and the second beam is less than a first threshold. The first threshold is, for example, a set threshold 8. If a channel difference between beams is less than 8, it may be determined that the two beams have the first QCL relationship.

In some embodiments, introduction of the first QCL relationship may serve as a new trigger state. Through calculation of the dynamic QCL relationship, the network device may generate a new trigger state for each predicted combination of top-K beams, and configure the trigger state to the first device together with the corresponding QCL relationship. The new CSI trigger state may include not only a combination of top-K beams but also a dynamic QCL relationship between these beams.

In an example, the network device may periodically or aperiodically trigger measurement of top-K beams based on an occasion or an event (for example, a change in a moving speed of the first device, a change in a channel condition) by using a PDCCH or other control signalling.

In some embodiments, the first QCL relationship may be used to trigger the first device to perform beam measurement. That is, the first device may perform CSI measurement based on the newly configured trigger state. Through introduction of the new trigger state of the dynamic QCL relationship, the network device can efficiently predict and measure top-K beams, thereby reducing signalling overheads and CSI measurement complexity. After measuring the CSI, the first device feeds back a CSI report of these beams to the network device.

In an example, determining the plurality of optimal beams based on the first QCL relationship may be equivalent to introducing a new trigger state with a dynamic QCL relationship for the predicted top-K beams.

In an example, in a case that the plurality of optimal beams have the first QCL relationship at a current instant, the first device measures one of the plurality of optimal beams, so as to determine measurement results of the plurality of optimal beams based on a measurement result of the one beam. Since the QCL relationship may indicate that beams have similar spatial characteristics (such as an angle or path delay), the first device may infer, based on CSI measurement of one beam, a channel state of another beam in the K optimal beams. It may be learned that, when the plurality of optimal beams are determined based on the first QCL relationship and measured, a quantity of individual CSI measurements may be reduced, that is, a quantity of beams that are required to be measured individually is reduced.

In an example, in a case that the plurality of optimal beams do not have the first QCL relationship at a current instant, the first device updates the plurality of optimal beams, and measures the plurality of optimal beams updated. The first device updates the plurality of optimal beams, such that the plurality of optimal beams updated have the first QCL relationship. It should be noted that the network device may alternatively re-adjust the QCL relationship between the top-K beams based on a periodic channel measurement result or beam updates performed based on AI model prediction. For example, as a channel condition or a mobility mode of the first device changes, the first QCL relationship may be updated on a periodic or event-triggered basis. For another example, when detecting a significant change in a channel environment (such as an increase in a speed of the first device or deterioration of channel quality), the network device may immediately update the first QCL relationship and notify the first device by using control signalling. In a case that the first QCL relationship is a dynamically adjustable QCL relationship, the system can adaptively respond to changes in the channel environment and the mobility mode of the first device, thereby improving accuracy of beam management and selection.

The plurality of new elements indicating the first QCL relationship and the method for determining the beam set or predicting the plurality of optimal beams based on the first QCL relationship are described above with reference to FIG. 4. The first QCL relationship may be indicated by using TCI information. The TCI state included in the TCI information may be considered as a set of specific beams or channel configurations, and is used to indicate which beam the first device should use for communication in a specific time instance. In some embodiments, maintaining consistency of the TCI state may ensure that the TCI state used in different timestamps is associated with the same CSI-RS resource, thereby enabling the first device to demodulate the DMRS by using the same channel estimation when processing transmissions at different timestamps.

In some embodiments, in the NZP CSI-RS resource in which trs-Info is configured, the first device may rely on these resources to infer time-frequency characteristics of a transmission beam (for example, by using the QCL Type A in Table 2) and potential spatial characteristics (for example, by using the QCL Type D/QCL Type E in Table 2). In the inference process, the network device may indicate the same CSI-RS resource as previously indicated for the PDSCH, so that the first device may use beam information that has been obtained by training, without performing channel measurement and estimation again, thereby ensuring consistency. If CSI-RS resources are configured with the higher-layer parameter trs-Info or are configured repeatedly, the first device may maintain consistent channel estimation at a plurality of timestamps by using these repeatedly configured CSI-RS resources. For example, at the plurality of timestamps, if a same NZP CSI-RS resource set is used and a channel correlation is established between CSI-RS resources in the resource set by using the QCL Type A and the QCL type D/QCL Type E, the first device may maintain a consistent channel model among these timestamps.

In some embodiments, in a case that the higher-layer parameter trs-Info is not configured, the first device may ensure the consistency among different timestamps by using a combination of the QCL type E in Table 2 and a conventional QCL type. That is, based on the beam set ID, the time instance, and the spatial filter parameter that indicate the first QCL relationship, consistent beam transmission characteristics can still be ensured even when the higher-layer parameter is not configured repeatedly.

To reduce transmission overheads, TCI states of a plurality of time instances may be indicated by using a single-beam indication. That is, the first indication information is one piece of indication information indicating a beam transmission configuration, and the first indication information includes a plurality of transmission configuration indicator TCI states corresponding to a plurality of time instances. In particular, for BM-Case2, TCI states of a plurality of time instances are indicated by using a single piece of TCI indication signalling, which can reduce transmission frequency of DCI without DL allocation, thereby reducing DCI overheads.

In some embodiments, the network device may give a single-beam indication by using control signalling, and the beam indication may be associated with a plurality of TCI states. The control signalling is the first indication information. By using the first indication information, the network device can more flexibly manage beam selection, without frequently indicating detailed configuration of each beam.

As described above, the first indication information may be carried in a PDCCH or RRC signalling. RRC signalling may be used for configuration on a relatively long time scale. For example, the network device may pre-configure usage time of these beams in periodic reports by using RRC signalling, such as indicating a specific effective time a TCI state (for example, a particular slot or symbol). For another example, the network device may indicate, in an actual transmission process by using dynamic PDCCH signalling, a use slot of a beam and a TCI state used by the first device in a corresponding slot.

In some embodiments, the network device may indicate, by using the first indication information, different TCI states that may be applied in different time instances. That is, the network device may notify the first device of an application slot of each TCI state in different time instances in a manner.

In an example, the system may pre-define or indicate, by using configuration signalling, time application instances of some beams to the first device. For example, the network device may indicate, by using a predefined time table, TCI states corresponding to different time instances. In this manner, the network device may use different TCI states in different time instances. For TCI states used in different time instances, the first device is required to learn a specific beam and an effective time corresponding to each TCI state.

In an example, in a case that the network device indicates, by using the first indication information, a plurality of TCI states of a plurality of time instances, a beam application time of each TCI state should be predefined or indicated to the first device. For example, a time window in which the first device performs beam prediction may be configured by a network.

In an example, the first device may determine an effective time of each TCI state by using a timing synchronization mechanism. For example, during system initialization, the network device may configure, by using RRC signalling, a set of beams and TCI states corresponding to the beams, and indicate different time instances in which these beams are used. By using a predefined time application rule, the system may predefine a mapping rule between a beam indication and different beams in a plurality of time instances by using RRC signalling. For another example, the network device may specify that a beam corresponds to different TCI states in a specific time subframe or slot. After receiving the first indication information, the first device may learn, based on a configured rule or signalling, a TCI state applied in each time instance, and automatically apply a corresponding TCI state based on the time instance, without receiving an individual beam indication each time.

In an example, the first indication information may be used by the first device to determine a TCI state table. The TCI state table may include a beam and an effective time that correspond to each TCI state in the plurality of TCI states. For example, the first device may maintain a TCI state table, where a beam and an effective time corresponding to each TCI state are recorded in the TCI state table.

In the example described above, when the network device transmits a beam indication by using control signalling, the first device may determine, by looking up the TCI state table, a beam that should be used in a current slot. By associating a plurality of TCI states with a single beam indication, the network device may significantly reduce overheads caused by frequent transmission of control signalling.

In the example described above, in a case that a beam indication transmitted by the network device is associated with a plurality of TCI states, the first device is required to learn, according to an indication from the network device, which TCI states are involved, and determine an applicable time according to the TCI state table. For example, for a beam in the first beam set, the first device may automatically switch to a beam used in a corresponding TCI state according to a time instance.

In an example, each beam indication may be reused in a plurality of time instances to reduce a requirement for individual indication for each slot or beam, and ensure consistency of an ID between the training process and the inference process.

In some embodiments, the first indication information may enable a single beam indication to be associated with different beams in a plurality of time instances. A plurality of TCI states in the first indication information may correspond to a plurality of beams, or may correspond to one beam. In an example, the plurality of TCI states are in a one-to-one correspondence with a plurality of beams. In an example, at least two TCI states in the plurality of TCI states correspond to one beam.

In an example, the plurality of beams corresponding to the plurality of TCIs may be the plurality of optimal beams mentioned above.

In some embodiments, the plurality of TCI states correspond to beams in a plurality of time instances. Before the first device applies a beam of a time instance, the network device may determine whether to change a TCI state of a Tx beam used for transmission.

For ease of understanding, the following describes, with reference to FIG. 5, a scenario in which a plurality of TCI states may change. Referring to FIG. 5, the AI/ML model may predict best beams of four future time instances T5, T6, T7, and T8 based on measurement results at time points T1, T2, T3, and T4. After model inference, the network may transmit a TCI state indication 1 (TCI indication 1) to notify the first device of a plurality of TCI states at T5, T6, T7, and T8. If the network determines to change TCI states at T7 and T8 before beam application time of T7 and T8, the network transmits a TCI state indication 2 (TCI indication 2) to update the TCI states of T7 and T8.

In FIG. 5, the TCI state indication 1 may be the first indication information, and the TCI state indication 2 may be second indication information.

In some embodiments, some or all of TCI states in the first indication information may be updated based on a dynamic indication. The dynamic indication may be referred to as second indication information. The second indication information may be used to indicate that at least one TCI state in the plurality of TCI states changes. In an example, the first device may receive the second indication information transmitted by the network device, so as to determine a latest TCI state.

In an example, the first device receives second indication information in a case that at least one TCI state in the plurality of TCI states changes, where the second indication information is used by the first device to update the at least one TCI state.

In an example, the second indication information may be carried in physical layer signalling. The physical layer signalling is, for example, a PDCCH. For example, the network device may dynamically indicate, by using physical layer signalling, which TCI state is to be used in each time instance.

In some embodiments, the first device may transmit an uplink reference signal to a second device, so that the second device determines whether to adjust the plurality of TCI states in the first indication information. For example, in a case that the second device is the network device, the second device may receive the uplink reference signal.

In an example, the uplink reference signal is, for example, a sounding reference signal (sounding reference signal, SRS). The SRS may quickly reflect a channel condition change of the first device. The network device may configure an SRS resource for the first device, and the first device may transmit an SRS periodically or as required. The SRS may be transmitted in a plurality of beam directions, which helps the network device measure channel quality at different angles. The SRS is generally transmitted by using an uplink, and may be transmitted across a plurality of antenna ports, so that the network device obtains complete channel state information. The network device evaluates uplink channel quality by using the received SRS. Due to certain symmetry (especially in a time division duplex (TDD) system) between an uplink channel and a downlink channel, the network device may infer channel quality of the downlink based on a result of SRS measurement.

In an example, the network device may measure a channel of the first device by using an SRS, and dynamically adjust a TCI state, thereby improving accuracy and efficiency of beam indication. Dynamically adjusting the TCI state may ensure that beam management can follow channel changes. The network device may infer channel conditions of the first device in different directions based on SRS measurement results, including parameters such as channel gain, delay, and Doppler spread in different beam directions. For example, based on SRS measurement results, the network device may dynamically adjust a beam configuration associated with each TCI state. In other words, the network device may select an appropriate beam based on a channel measurement result, and associate it with different TCI states. For another example, by analyzing an SRS signal, the network device may determine which beam direction offers best channel quality for the first device.

In an example, the network device may instruct the first device to update the TCI states by using RRC signalling or PDCCH signalling. After receiving a TCI state indication from the network device, the first device may demodulate and decode data transmission by using a corresponding beam according to a configuration from the network device, and therefore, may determine a best first beam set. For example, when the network device selects a set of new TCI states, the first device updates a configuration received by the first device, so that physical channels such as a PDSCH can be received in an updated beam direction. This mechanism may allow a plurality of TCI states to be bound to different beams, enabling management and optimization of a plurality of beams.

For example, with reference to beam sweeping and SRS feedback, the network device may always select an optimal first beam set and transmit it to the first device.

In an example, the network device may configure the first device to periodically transmit an SRS, so as to dynamically track a channel change of the first device and adjust a TCI state in real time. By updating the TCI state in a timely manner, it can be ensured that downlink beam transmission is highly matched with channel characteristics, especially in an environment with high mobility or rapid channel changes.

The foregoing describes the method embodiments of the present application in detail with reference to FIG. 1 to FIG. 5. The following describes in detail the apparatus embodiments of the present application with reference to FIG. 6 to FIG. 8. It should be understood that the description of the apparatus embodiments corresponds to the description of the method embodiments. Therefore, for parts that are not described in detail, one may refer to the foregoing method embodiments.

FIG. 6 is a schematic block diagram of an apparatus for wireless communication according to an embodiment of the present application. The apparatus 600 may be any one of the first devices described above. The first device may be a terminal device. The apparatus 600 shown in FIG. 6 includes a transceiver unit 610 and a processing unit 620.

The transceiver unit 610 may be configured to receive first indication information, where the first indication information is used to indicate a first QCL relationship. The processing unit 620 may be configured to perform a first operation based on the first QCL relationship. The first operation is one or more of the following: determining a beam set used for model training and/or model inference, where an element of the first QCL relationship includes an identifier of the beam set; or determining a plurality of optimal beams in a model prediction result.

Optionally, the first QCL relationship further includes one or more of the following elements: a time instance related to model training and/or model inference; or a spatial filter parameter related to a beam set.

Optionally, in a case that the element of the first QCL relationship includes the spatial filter parameter, the model training and the model inference correspond to a same spatial filter.

Optionally, in a case that the first QCL relationship is indicated by using a first QCL type, the first QCL type is one of the following: a QCL type A, a QCL type B, a QCL type C, a QCL type D, or a QCL type E.

Optionally, the first QCL relationship is indicated by using a first QCL type, and in a case that the first QCL type is a QCL type E, the first QCL relationship is indicated by using a second QCL type, and the second QCL type includes at least one of a QCL type A, a QCL type B, a QCL type C, or a QCL type D.

Optionally, the beam set used for model training and/or model inference further meets one or more of the following conditions: a first beam set used for the model training and a first beam set used for the model inference have the first QCL relationship; a second beam set used for the model training and a second beam set used for the model inference have the first QCL relationship; a first beam set and a second beam set that are used for the model training have the first QCL relationship; or a first beam set and a second beam set that are used for the model inference have the first QCL relationship. The first beam set is used to determine a plurality of optimal beams from the second beam set.

Optionally, the first indication information is one piece of indication information indicating a beam transmission configuration, and the first indication information includes a plurality of transmission configuration indicator TCI states corresponding to a plurality of time instances.

Optionally, the plurality of TCI states are in a one-to-one correspondence with a plurality of beams, or at least two TCI states in the plurality of TCI states correspond to one beam.

Optionally, the first indication information is used by the first device to determine a TCI state table, and the TCI state table includes a beam and an effective time that correspond to each TCI state in the plurality of TCI states.

Optionally, the transceiver unit 610 may be further configured to transmit an uplink reference signal, where the uplink reference signal is used to determine whether to adjust the plurality of TCI states; and receive second indication information in a case that at least one TCI state in the plurality of TCI states changes, where the second indication information is used by the first device to update the at least one TCI state.

Optionally, the second indication information is carried in physical layer signalling.

Optionally, the plurality of optimal beams have the first QCL relationship, and the first QCL relationship is used to determine one or more of the following: the plurality of optimal beams correspond to a same channel characteristic; the plurality of optimal beams correspond to a same delay characteristic; the plurality of optimal beams correspond to a same beam set identifier; or the plurality of optimal beams correspond to a same spatial parameter or spatial filter parameter.

Optionally, the plurality of optimal beams include a first beam and a second beam, and a difference between two channel characteristics respectively corresponding to the first beam and the second beam is less than a first threshold.

Optionally, the processing unit 620 is further configured to: in a case that the plurality of optimal beams have the first QCL relationship at a current instant, measure one of the plurality of optimal beams; or in a case that the plurality of optimal beams do not have the first QCL relationship at a current instant, update the plurality of optimal beams, and measure the plurality of optimal beams updated.

Optionally, the first indication information is carried in one of the following information: downlink control information or radio resource control signalling.

Optionally, the first operation is related to a first model, and the first model is an artificial intelligence or machine learning model.

FIG. 7 is a schematic block diagram of another apparatus for wireless communication according to an embodiment of the present application. The apparatus 700 may be any second device described above. The second device is a network device or a terminal device. The apparatus 700 shown in FIG. 7 includes a transceiver unit 710.

The transceiver unit 710 may be configured to transmit first indication information to a first device, where the first indication information is used to indicate a first QCL relationship, and the first QCL relationship is used by the first device to perform a first operation. The first operation is one or more of the following: determining a beam set used for model training and/or model inference, where an element of the first QCL relationship includes an identifier of the beam set; or determining a plurality of optimal beams in a model prediction result.

Optionally, the first QCL relationship further includes one or more of the following elements: a time instance related to model training and/or model inference; or a spatial filter parameter related to a beam set.

Optionally, in a case that the element of the first QCL relationship includes the spatial filter parameter, the model training and the model inference correspond to a same spatial filter.

Optionally, in a case that the first QCL relationship is indicated by using a first QCL type, the first QCL type is one of the following: a QCL type A, a QCL type B, a QCL type C, a QCL type D, or a QCL type E.

Optionally, the first QCL relationship is indicated by using a first QCL type, and in a case that the first QCL type is a QCL type E, the first QCL relationship is indicated by using a second QCL type, and the second QCL type includes at least one of a QCL type A, a QCL type B, a QCL type C, or a QCL type D.

Optionally, the beam set used for model training and/or model inference further meets one or more of the following conditions: a first beam set used for the model training and a first beam set used for the model inference have the first QCL relationship; a second beam set used for the model training and a second beam set used for the model inference have the first QCL relationship; a first beam set and a second beam set that are used for the model training have the first QCL relationship; or a first beam set and a second beam set that are used for the model inference have the first QCL relationship. The first beam set is used to determine a plurality of optimal beams from the second beam set.

Optionally, the first indication information is one piece of indication information indicating a beam transmission configuration, and the first indication information includes a plurality of transmission configuration indicator TCI states corresponding to a plurality of time instances.

Optionally, the plurality of TCI states are in a one-to-one correspondence with a plurality of beams, or at least two TCI states in the plurality of TCI states correspond to one beam.

Optionally, the first indication information is used by the first device to determine a TCI state table, and the TCI state table includes a beam and an effective time that correspond to each TCI state in the plurality of TCI states.

Optionally, the transceiver unit 710 is further configured to receive an uplink reference signal, where the uplink reference signal is used to determine whether to adjust the plurality of TCI states; and transmit second indication information in a case that at least one TCI state in the plurality of TCI states changes, where the second indication information is used by the first device to update the at least one TCI state.

Optionally, the second indication information is carried in physical layer signalling.

Optionally, the plurality of optimal beams have the first QCL relationship, and the first QCL relationship is used to determine one or more of the following: the plurality of optimal beams correspond to a same channel characteristic; the plurality of optimal beams correspond to a same delay characteristic; the plurality of optimal beams correspond to a same beam set identifier; or the plurality of optimal beams correspond to a same spatial parameter or spatial filter parameter.

Optionally, the plurality of optimal beams include a first beam and a second beam, and a difference between two channel characteristics respectively corresponding to the first beam and the second beam is less than a first threshold.

Optionally, the first QCL relationship is further used to trigger the first device to perform beam measurement, and in a case that the plurality of optimal beams have the first QCL relationship at a current instant, beam measurement is performed on one of the plurality of optimal beams; or in a case that the plurality of optimal beams do not have the first QCL relationship at a current instant, the beam measurement is performed on a plurality of optimal beams updated.

Optionally, the first indication information is carried in one of the following information: downlink control information or radio resource control signalling.

Optionally, the first operation is related to a first model, and the first model is an artificial intelligence or machine learning model.

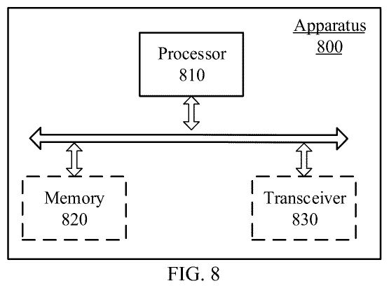

FIG. 8 is a schematic structural diagram of a communications apparatus according to an embodiment of the present application. Dashed lines in FIG. 8 indicate that a unit or module is optional. The apparatus 800 may be configured to implement the methods described in the foregoing method embodiments. The apparatus 800 may be a chip, a terminal device, or a network device.

The apparatus 800 may include one or more processors 810. The processor 810 may support the apparatus 800 in implementing the methods described in the foregoing method embodiments. The processor 810 may be a general-purpose processor or a dedicated processor. For example, the processor may be a central processing unit (central processing unit, CPU).

Alternatively, the processor may be another general-purpose processor, a digital signal processor (digital signal processor, DSP), an application-specific integrated circuit (application-specific integrated circuit, ASIC), a field-programmable gate array (field-programmable gate array, FPGA) or another programmable logic device, a discrete gate or transistor logic device, a discrete hardware component, or the like. The general-purpose processor may be a microprocessor, or the processor may be any conventional processor or the like.

The apparatus 800 may further include one or more memories 820. The memory 820 stores a program, and the program may be executed by the processor 810, so that the processor 810 executes the method described in the foregoing method embodiments. The memory 820 may be separate from the processor 810 or may be integrated into the processor 810.

The apparatus 800 may further include a transceiver 830. The processor 810 may communicate with another device or chip by using the transceiver 830. For example, the processor 810 may transmit data to and receive data from another device or chip by using the transceiver 830.

An embodiment of the present application further provides a computer-readable storage medium for storing a program. The computer-readable storage medium may be applied to the terminal device or the network device provided in embodiments of the present application, and the program causes a computer to execute a method executed by the terminal device or the network device in various embodiments of the present application.

The computer-readable storage medium may be any available medium accessible by a computer or a data storage device such as a server or a data center that integrates one or more available media. The usable medium may be a magnetic medium (for example, a floppy disk, a hard disk, or a magnetic tape), an optical medium (for example, a digital video disc (digital video disc, DVD)), a semiconductor medium (for example, a solid state drive (solid state drive, SSD)), or the like.

An embodiment of the present application further provides a computer program product. The computer program product includes a program. The computer program product may be applied to the terminal device or the network device provided in embodiments of the present application, and the program causes a computer to execute the methods executed by the terminal device or the network device in various embodiments of the present application.

All or some of the foregoing embodiments may be implemented by using software, hardware, firmware, or any combination thereof. When the software is used to implement embodiments, all or some of embodiments may be implemented in a form of a computer program product. The computer program product includes one or more computer instructions. When the computer program instructions are loaded and executed on a computer, the procedures or functions according to embodiments of the present application are completely or partially generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from a website, computer, server, or data center to another website, computer, server, or data center in a wired (for example, a coaxial cable, an optical fiber, and a digital subscriber line (digital subscriber line, DSL)) manner or a wireless (for example, infrared, wireless, and microwave) manner.

An embodiment of the present application further provides a computer program. The computer program may be applied to the terminal device or the network device provided in embodiments of the present application, and the computer program causes a computer to execute the methods executed by the terminal device or the network device in various embodiments of the present application.

The terms “system” and “network” in the present application may be used interchangeably. In addition, the terms used in the present application are merely used to explain the specific embodiments of the present application, and are not intended to limit the present application. In the specification, claims, and accompanying drawings of the present application, the terms “first”, “second”, “third”, “fourth”, and so on are intended to distinguish between different objects but do not describe a particular sequence. In addition, the terms “include” and “have” and any variations thereof are intended to cover a non-exclusive inclusion.

In embodiments of the present application, “indicate” mentioned herein may be a direct indication, or may be an indirect indication, or may mean that there is an association relationship. For example, A indicates B, which may mean that A directly indicates B, for example, B may be obtained by using A; or may mean that A indirectly indicates B, for example, A indicates C, and B may be obtained by using C; or may mean that there is an association relationship between A and B.

In embodiments of the present application, the term “corresponding” may mean that there is a direct or indirect correspondence between two elements, or that there is an association between two elements, or that there is a relationship of “indicating” and “being indicated”, “configuring” and “being configured”, or the like.

In embodiments of the present application, “pre-defining” or “pre-configuring” can be implemented by pre-storing corresponding codes, tables, or other forms that may be used to indicate related information in devices (for example, including a terminal device and a network device). A specific implementation thereof is not limited in the present application. For example, being predefined may refer to being defined in a protocol.

In embodiments of the present application, the “protocol” may refer to a standard protocol in the communications field, and may include, for example, an LTE protocol, an NR protocol, and a related protocol applied to a future communications system, which is not limited in the present application.

In embodiments of the present application, determining B based on A does not mean determining B based on only A, but instead B may be determined based on A and/or other information.

In embodiments of the present application, the term “and/or” is merely an association relationship that describes associated objects, and represents that there may be three relationships. For example, A and/or B may represent three cases: only A exists, both A and B exist, and only B exists. In addition, the character “/” in this specification generally indicates an “or” relationship between the associated objects.

In embodiments of the present application, sequence numbers of the foregoing processes do not mean execution orders. The execution orders of the processes should be determined based on functions and internal logic of the processes, and should not be construed as any limitation on the implementation processes of embodiments of the present application.

In several embodiments provided in the present application, it should be understood that the disclosed system, apparatus, and method may be implemented in another manner. For example, the foregoing described apparatus embodiments are merely examples. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electronic, mechanical, or another form.

The units described as separate parts may be or may not be physically separate, and parts displayed as units may be or may not be physical units, and may be at one location, or may be distributed on a plurality of network elements. Some or all of the units may be selected depending on actual requirements to achieve the objectives of the solutions in the embodiments.

In addition, functional units in embodiments of the present application may be integrated into one processing unit, or each of the units may exist alone physically, or two or more units may be integrated into one unit.

The foregoing descriptions are merely specific implementations of the present application, but the protection scope of the present application is not limited thereto. Any variation or replacement readily figured out by a person skilled in the art within the technical scope disclosed in the present application shall fall within the protection scope of the present application. Therefore, the protection scope of the present application shall be subject to the protection scope of the claims.

What is claimed is:

1. A method for wireless communication, comprising:
receiving, by a first device, first indication information, wherein the first indication information indicates a first quasi co-location (QCL) relationship; and
determining, by the first device based on the first QCL relationship, at least one of the following:
a beam set used for at least one of model training or model inference, wherein an element of the first QCL relationship comprises an identifier of the beam set; or
a plurality of optimal beams in a model prediction result.

2. The method according to claim 1, wherein the first QCL relationship further comprises one or more of following elements:
a time instance related to at least one of the model training or the model inference; or
a spatial filter parameter related to the beam set.

3. The method according to claim 2, wherein the element of the first QCL relationship comprises the spatial filter parameter, the model training and the model inference correspond to a same spatial filter.

4. The method according to claim 1, wherein the first QCL relationship is indicated by using a first QCL type, and the first QCL type is one of following: a QCL type A, a QCL type B, a QCL type C, a QCL type D, or a QCL type E.

5. The method according to claim 1, wherein the first QCL relationship is indicated by using a first QCL type, and when the first QCL type is a QCL type E, the first QCL relationship is indicated by using a second QCL type, and the second QCL type comprises at least one of a QCL type A, a QCL type B, a QCL type C, or a QCL type D.

6. The method according to claim 1, wherein the beam set used for at least one of model training or model inference meets one or more of following conditions:
a first beam set used for the model training and a first beam set used for the model inference have the first QCL relationship;
a second beam set used for the model training and a second beam set used for the model inference have the first QCL relationship;
a first beam set and a second beam set that are used for the model training have the first QCL relationship; or
a first beam set and a second beam set that are used for the model inference have the first QCL relationship,
wherein the first beam set is used to determine a plurality of optimal beams from the second beam set.

7. The method according to claim 1, wherein the first indication information is one piece of indication information indicating a beam transmission configuration, and the first indication information comprises a plurality of transmission configuration indicator (TCI) states corresponding to a plurality of time instances.

8. The method according to claim 7, wherein the plurality of TCI states are in a one-to-one correspondence with a plurality of beams, or at least two TCI states in the plurality of TCI states correspond to one beam.

9. The method according to claim 7, wherein the first indication information is used by the first device to determine a TCI state table, and the TCI state table comprises a beam and an effective time that correspond to each TCI state in the plurality of TCI states.

10. The method according to claim 7, further comprising:
transmitting, by the first device, an uplink reference signal, wherein the uplink reference signal is used to determine whether to adjust the plurality of TCI states; and
receiving, by the first device, second indication information when at least one TCI state in the plurality of TCI states changes, wherein the second indication information is used by the first device to update the at least one TCI state.

11. The method according to claim 10, wherein the second indication information is carried in physical layer signalling.

12. The method according to claim 1, wherein the plurality of optimal beams have the first QCL relationship, and the first QCL relationship is used to determine one or more of following:
the plurality of optimal beams correspond to a same channel characteristic;
the plurality of optimal beams correspond to a same delay characteristic;
the plurality of optimal beams correspond to a same beam set identifier; or
the plurality of optimal beams correspond to a same spatial parameter or spatial filter parameter.

13. The method according to claim 12, wherein the plurality of optimal beams comprise a first beam and a second beam, and a difference between two channel characteristics respectively corresponding to the first beam and the second beam is less than a first threshold.

14. The method according to claim 1, wherein the first QCL relationship is further used to trigger the first device to perform beam measurement, and the method further comprises:
in a case that the plurality of optimal beams have the first QCL relationship at a current instant, measuring, by the first device, one of the plurality of optimal beams; or
in a case that the plurality of optimal beams do not have the first QCL relationship at a current instant, updating, by the first device, the plurality of optimal beams, and measuring the plurality of optimal beams updated.

15. The method according to claim 1, wherein the first indication information is carried in one of following information: downlink control information or radio resource control signalling.

16. The method according to claim 1, wherein the determining is related to a first model, and the first model is an artificial intelligence or machine learning model.

17. A method for wireless communication, comprising:
transmitting, by a second device, first indication information to a first device, wherein the first indication information indicates a first quasi co-location (QCL) relationship, and the first QCL relationship is used to determine at least one of
a beam set used for at least one of model training or model inference, wherein an element of the first QCL relationship comprises an identifier of the beam set; or
a plurality of optimal beams in a model prediction result.

18. An apparatus, comprising:
at least one processor; and
one or more non-transitory computer-readable storage media coupled to the at least one processor and storing programming instructions for execution by the at least one processor, wherein the programming instructions, when executed, cause the apparatus to perform operations comprising:
receiving first indication information, wherein the first indication information indicates a first quasi co-location (QCL) relationship; and
determining, based on the first QCL relationship, at least one of the following:
a beam set used for at least one of model training or model inference, wherein an element of the first QCL relationship comprises an identifier of the beam set; or
a plurality of optimal beams in a model prediction result.

19. The apparatus according to claim 18, wherein the first QCL relationship further comprises one or more of following elements:
a time instance related to at least one of the model training or the model inference; or
a spatial filter parameter related to the beam set.

20. The apparatus according to claim 19, wherein the element of the first QCL relationship comprises the spatial filter parameter, the model training and the model inference correspond to a same spatial filter.
